(19) United States
(12) Patent Application Publication
(10) Pub. No.: US 2025/0276878 A1
(43) Pub. Date: Sep. 4, 2025

(54) Remote crane cockpit

(71) Applicant: Crane Cockpit Technologies Ltd., Herzlia (IL)

(72) Inventor: Aviv Carmel, Hod-HaSharon (IL)

(21) Appl. No.: 18/858,769

(22) PCT Filed: Apr. 20, 2023
(86) PCT No.: PCT/IL2023/050409

§ 371 Date: Oct. 22, 2024

(30) Foreign Application Priority Data
Apr. 25, 2022 (IL) 292501

(51) Int. Cl. B66C 13/40; B66C 13/54; B66C 15/06

(52) U.S. Cl. CPC B66C 13/40; B66C 13/54; B66C 15/065

(57) ABSTRACT

Remote crane cockpit apparatus for remotely controlling at least one crane by an operator. The apparatus includes a disregard-thwarting system for thwarting disregard of alarm indication by the operator. The disregard-thwarting system includes at least one alarm indicator configured to induce sensory stimulation, which can be dynamically varied in correlation to parameters that may include danger level perseverance, operator response time, and operator reaction-score. The alarm indication may include a secondary sense stimulator.

### FIELD OF THE INVENTION

The present invention relates generally to the field of remote operating of a machine or system, and more specifically to remote operating of a crane.

### BACKGROUND OF THE INVENTION

The field of distanced control of electronic systems and devices is constantly developing, hand-in-hand with the constant development of improved wireless technologies. Along with the obvious advantages of being able to operate a machine from a distance without physical contact, this also creates some issues which require handling. Specifically, the operators intake of the surroundings of the operated machine are severely compromised by the distancing of the operator, which may lead to unawareness of sudden changes in the surrounding environments or of imminent risks or hazards.

### SUMMARY OF THE INVENTION

In accordance with one aspect of the present invention, there is thus provided a remote crane cockpit apparatus for remotely controlling at least one crane by an operator, including a disregard-thwarting system for thwarting disregard of alarm indication by the operator. The disregard thwarting system includes at least one alarm indicator operational for inducing sensory stimulation, wherein the sensory stimulation is dynamically varied in correlation to danger level or perseverance. The alarm indicator may include at least one of:
a display of a scenery of interest which is varied;
a visual alert display;
automatic focusing on an object of particular interest/requiring particular attention;
a flickering light/display;
a light-control for flickering the ambient lighting;
a gas-sprayer for spraying strong smelling gas;
an alarm for sounding a message/sound/alert;
a tactile vibrator for vibrating a handle/stick/chair in physical contact interface with the operator; and
a source of an electric current in physical contact interface with the operator.

The sensory stimulation may be progressively augmented in correlation to increase of danger level or perseverance and may be progressively reduced in correlation to decrease of danger level. The sensory stimulation may be varied with an exponential correlation to the danger level or perseverance. The sensory stimulation may be varied with a linear correlation to the danger level or perseverance. The sensory stimulation may be varied by a step intervals function in correlation to the danger level or perseverance. The sensory stimulation may be progressively augmented by intensifying a first sensory stimulation produced by a first alarm indicator, and may be progressively reduced by diminishing the first sensory stimulation produced by the first alarm indicator. The sensory stimulation may be progressively augmented by activating a plurality of alarm indicators which respectively produce a plurality of sensory stimulations, and may be progressively reduced by deactivating the plurality of alarm indicators. The sensory stimulation may be dynamically varied according to a fixed program. The sensory stimulation may be dynamically varied according to a randomly changing program.

The remote crane cockpit apparatus may further include a controller, wherein the controller is operational for recording respective response-time of an operator to a variety of activated sensory stimulations, and analyzing the response-time of the operator. The controller is further operational to define a reaction-score of the operator to each of the variety of activated sensory stimulations, and to dynamically vary the sensory stimulation according to the reaction-score.

The sensory stimulation may include a visual display of real time imaging of a scene of interest, wherein the sensory stimulation is progressively augmented or reduced by variation of scene shading between calm shading and strong shading. The sensory stimulation may include a visual display of real time imaging of a scene of interest, wherein the sensory stimulation is progressively augmented or reduced by variation of scene coloring between soft colors and strong colors. The sensory stimulation may include a visual display of real time imaging of a scene of interest, wherein the sensory stimulation is progressively augmented or reduced by variation of brightness.

The alarm indicator may include a required-action indicator. The disregard-thwarting system may further include a real-time-conditions indicator for imitating real-time conditions of the monitored crane. The real-time-conditions indicator may include at least one of: surround-speaker for sounding crane real time environmental noises as heard and perceived by a microphone in the vicinity of the monitored crane; wind simulator for simulating the windblow at a cockpit-location of the monitored crane by blowing air and/or sounding windblow sound; and a vibrating seat, for imitating vibrations at a cockpit-location.

The danger level may be considered by evaluating azimuth deviation of the working arm of a loose crane respective of wind direction when wind intensity is above a threshold which can lead to falling over of the crane.

The remote crane cockpit apparatus may further include an automatic intervention controller operational for actively preventing a dangerous situation. The automatic intervention controller is operative to control a slewing means for correcting azimuth deviation of the working arm of a loose crane respective of wind direction when the azimuth deviation and/or wind intensity are beyond a threshold, for preventing falling over of the crane. The alarm indicator may be personally setup for a particular operator, and configured for an initial setup suited to the particular operator.

In accordance with another aspect of the present invention, there is thus provided a method for remotely controlling a crane cockpit for at least one crane by an operator, including thwarting disregard of alarm indication by the operator. Thwarting disregard of alarm indication includes the procedures of detecting a potential danger by at least one danger-sensor in the vicinity of the at least one crane, inducing sensory stimulation with at least one alarm indicator in response to the detected danger, and dynamically varying the sensory stimulation in correlation to danger level or perseverance. The alarm indicator may include at least one of:
a display of a scenery of interest which is varied;
a visual alert display;
automatic focusing on an object of particular interest/requiring particular attention;
a flickering light/display;
a light-control for flickering the ambient lighting;
a gas-sprayer for spraying strong smelling gas;
an alarm for sounding a message/sound/alert;
a tactile vibrator for vibrating a handle/stick/chair in physical contact interface with the operator; and
a source of an electric current in physical contact interface with the operator.

Dynamically varying the sensory stimulation may include progressively augmenting the sensory stimulation in correlation to increase of danger level or perseverance, and progressively reducing the sensory stimulation in correlation to decrease of danger level. Dynamically varying the sensory stimulation may further include varying the sensory stimulation with an exponential correlation to the danger level or perseverance. Dynamically varying the sensory stimulation may further include varying the sensory stimulation with a linear correlation to the danger level or perseverance. Dynamically varying the sensory stimulation may further include varying the sensory stimulation by a step intervals function in correlation to the danger level or perseverance.

Dynamically varying the sensory stimulation may include intensifying and/or diminishing a first sensory stimulation produced by a first alarm indicator. Dynamically varying the sensory stimulation may further include activating and/or deactivating a plurality of alarm indicators which respectively produce a plurality of sensory stimulations. Dynamically varying the sensory stimulation may be according to a fixed program. Dynamically varying the sensory stimulation may be according to a randomly changing program.

The method for remotely controlling crane cockpit may further include the procedures of: recording respective response-time and/or quality of response of an operator to a variety of activated sensory stimulations; analyzing the response-time and/or quality of response of the operator; computing and defining a reaction-score of the operator for each of the variety of activated sensory stimulations; and dynamically varying the sensory stimulation according to the reaction-score.

Dynamically varying the sensory stimulation may further include varying scene shading of a real time imaging of a scene of interest between calm shading and strong shading, to augment or reduce the sensory stimulation. Dynamically varying the sensory stimulation may further include varying scene coloring of a real time imaging of a scene of interest between soft colors and strong colors, to augment or reduce the sensory stimulation. Dynamically varying the sensory stimulation may further include varying scene brightness of a real time imaging of a scene of interest to augment or reduce the sensory stimulation.

The alarm indicator may further include a required-action indicator. The method may further include the procedure of providing real-time-conditions indications for imitating real-time conditions of the monitored crane. Providing real-time-conditions indications may include at least one: sounding crane real time environmental noises as heard and perceived by a microphone in the vicinity of the monitored crane; simulating the windblow at a cockpit-location of the monitored crane by blowing air and/or sounding windblow sounds; and vibrating a seat of the operator, for imitating vibrations at a cockpit-location of the monitored crane.

Detecting a potential danger may include evaluating azimuth deviation of the working arm of a loose crane respective of wind direction, and detecting when wind intensity is above a threshold which can lead to falling over of the crane.

The method may further include the procedure of automatically intervening in the operation of the crane to actively prevent a dangerous situation. Actively preventing a dangerous situation may include correcting azimuth deviation of the working arm of a loose crane respective of wind direction when the azimuth deviation and/or wind intensity are beyond a threshold, for preventing falling over of the crane. Inducing sensory stimulation may further include the procedure of setting up the alarm indicator to be personally suited for a particular operator.

### BRIEF DESCRIPTION OF THE DRAWINGS

The present invention will be understood and appreciated more fully from the following detailed description taken in conjunction with the drawings in which:

FIG. 1A is a schematic illustration of a crane cockpit apparatus, constructed and operative according to the present invention, and a crane;

FIG. 1B is a schematic illustration of a variety of sensors in communication with The remote crane cockpit apparatus and mounted on the crane of FIG. 1A;

FIG. 1C is a schematic illustration of coupled mutual detectors mounted on the crane of FIG. 1A and on neighboring tree;

FIG. 2A is an illustration of The remote crane cockpit apparatus and the crane of FIG. 1A, where alarm indicators are activated in response to a predicted hazard;

FIG. 2B is an illustration of The remote crane cockpit apparatus and the crane of FIG. 1A, where a required-action indicator is activated in response to a predicted hazard;

FIG. 2C is an illustration of The remote crane cockpit apparatus and the crane of FIG. 1A, where an automatic intervention is activated in response to a suddenly appearing hazard;

FIGS. 3A to 3C illustrate a sequence of live images shown upon a screen with changing display settings in response to data indicative of a potential defect or hazard. FIG. 3A is a schematic illustration of a visual display of real time imaging of a the crane shown on a screen of The remote crane cockpit apparatus of FIG. 1A, where the contrast between the crane and its background environment is at a baseline level;

FIG. 3B is a schematic illustration of the visual display of FIG. 3A, where the contrast between the crane and its background environment is increased due to a detected danger/defect;

FIG. 3C is a schematic illustration of the visual display of FIG. 3B, where the contrast between the crane and its background environment is increased due to a perseverance and/or escalation of the detected danger/defect;

FIG. 4 is a schematic illustration of The remote crane cockpit apparatus of FIG. 1A, including real-time-conditions indicators located in the vicinity of the operator of The remote crane cockpit apparatus;

FIG. 5 is a block diagram of a method for remotely controlling crane cockpit for at least one crane by an operator, operative in accordance with an embodiment of the present invention;

FIG. 6 is a block diagram of sub-routines or sub-procedures of step 512 of the embodiment of FIG. 5; and

FIG. 7 is a block diagram of sub-routines or sub-procedures of step 514 of the embodiment of FIG. 5.

### DETAILED DESCRIPTION OF THE EMBODIMENTS

The present invention addresses the above-mentioned issues by providing a crane cockpit apparatus for remote control of at least one crane by an operator. The remote crane cockpit apparatus includes an alert system which is intended and designed for thwarting disregard of an alarm indication by the operator. The alert system includes a variable sensory-stimulant alarm indicator, configured to induce sensory stimulation to the operator, wherein said sensory stimulation is dynamically varied in correlation to danger level or perseverance. The sensory stimulation may include visual, audio, tactile, olfactory and/or psychological stimulation, or any combination thereof. The dynamical variation of the sensory stimulations may include continuously raising the level of a particular stimulation, changing between or adding different stimulations according to a particular pattern, randomly changing between different stimulations, activating and deactivating the stimulation if a stop-start pattern, or any other possibility of stimulation variation. Optionally, the system may be configured to track, record, and analyze the responses to various stimulations of each individual operator, so as to construct a personalized stimulation program for each operator. The operation of the system will now be further explained with reference to the illustrations.

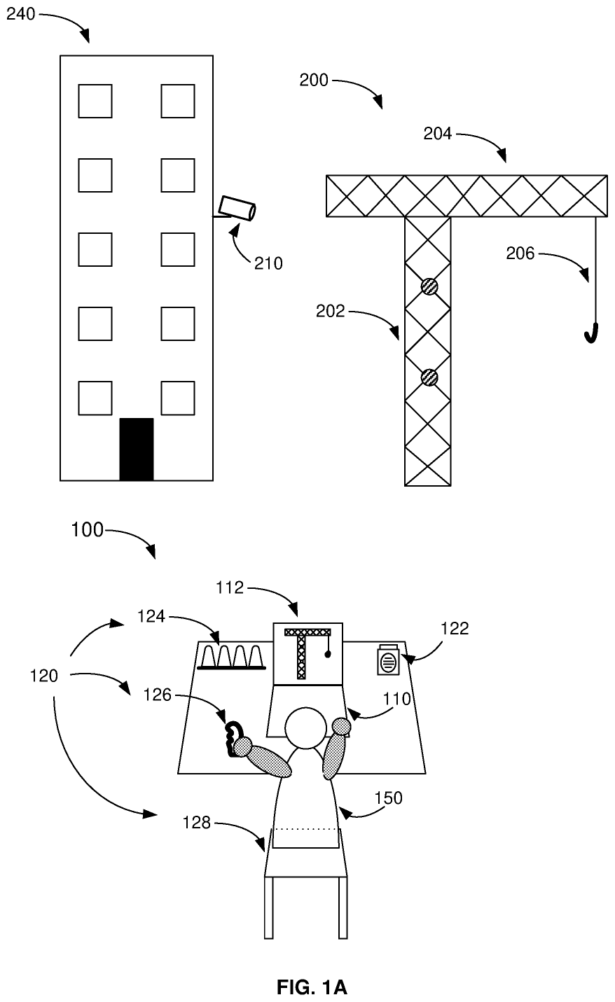

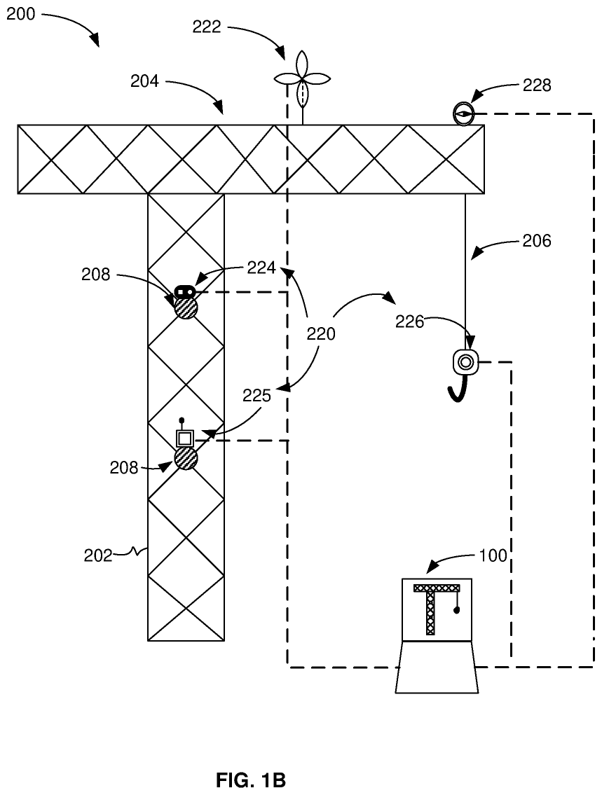

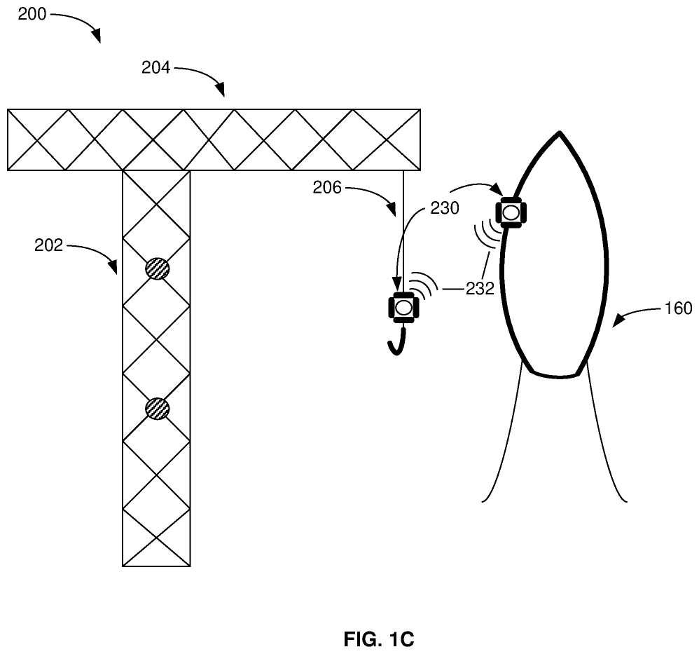

Reference is made to FIG. 1A, which is a schematic illustration of a crane cockpit apparatus, hereby referenced 100, constructed and operative according to the present invention. Crane cockpit apparatus 100 includes controller 110 and screen 112, for following and controlling the operation of a crane, referenced 200. Crane 200 includes vertical crane mast 202, jib 204 which is positioned at a top region of crane mast 202 and perpendicular thereto, coupling pins 208 which connect the mast sections of mast 202, and hoist-and-hook 206 which is suspended from jib 204 and is configured to have a load connected to its end and to be extended and retracted according to need. Apparatus 100 further includes alarm indicators 120 like audio alarm 122, flickering light/display 124 and various forms of a secondary sense stimulator. The secondary senses include the tactile and olfactory senses. Secondary sense stimulator includes either a tactile vibrator 126, a electric shocker 128 or a heater, or a combination or one or more of them. All alarm indicators are also controlled by controller 110. In a certain embodiment, the heater is mounted in a table or a chair. When mounted within a chair, in a certain variant embodiment the heaters or mounted in the chair seat, or either of the arm rests or both of them, or the back rest, or a combination of them. The heating temperature is configurable and can be configured to heat to a temperature that causing a non-attentive operator to recoil from the heat around 60° or 65° C., for example. In a certain variant embodiment when the heating element is mounted in a chair seat, the heating element is linked to a pressure sensor configured to deactivate the heating element responsively to a pressure reduction on the chair seat. This configuration advantageously stops heating after an operator stands because one can assume that the reduction of seat pressure indicates that the operator has stood up and has regained the required situational awareness. Visual recording device 210 is mounted upon building 240, and is operational to continuously record crane 200 and its surroundings and supply visual data to operator 150 via controller 110.

The components and devices of apparatus 100 may be based in hardware, software, or combinations thereof. It is appreciated that the functionality associated with each of the devices or components of apparatus 100 may be distributed among multiple devices or components, which may reside at a single location or at multiple locations. For example, the functionality associated with controller 110 may be distributed between multiple processing units. Controller 110 may be part of a server or a remote computer system accessible over a communications medium or network, or may be integrated with other components of apparatus 100, such as incorporated with image sensor 220. Apparatus 100 may optionally include and/or be associated with additional components not shown in FIG. 1, for enabling the implementation of the disclosed subject matter. For example, apparatus 100 may include a memory or storage unit (not shown) for temporary storage of images or other data.

The operation of remote crane tracking apparatus 100 will now be described in general terms, followed by specific examples.

Operator 150 manages and follows the operation of crane 200 by the use of controller 110 and screen 112. Crane 200 is continuously monitored by visual recording device 210, such that the data recorded by recording device 210 is substantially instantaneously transmitted to controller 110 and translated into a visual image which is displayed upon screen 112. Controller 110 is operational to manage all operations of crane 200, such as rotating of a working arm/jib, i.e., changing the azimuth thereof; extending and retracting of a working arm/jib; lowering and collecting of a load hoist; and any other operation of a crane as known in the art, particularly the crane operations which are usually controlled by a crane cockpit located on the crane. In addition, controller 110 is configured to recognize safety hazards and/or other defects of crane 200, according to predefined parameters and data collected by a variety of sensors, which are installed upon crane 200 or in the vicinity thereof.

With reference to FIG. 1B, which is an illustration of a variety of danger-sensors 220 mounted on crane 200 in the vicinity thereof, and in communication with controller 110, some examples of the variety of sensors and the corresponding safety hazards and/or crane defects which the sensors may allow to predict and/or detect, are herein described. (1) Wind sensor 222 is mounted on jib 204, and is configured to detect the force and direction of the wind blowing at the height of jib 204 above ground, and transmit the data which it collects to controller 110. A single wind sensor 222 may be omni-directional; alternatively, a plurality of wind sensors 222 may be installed such that they point in different directions, and controller 110 can calculate the wind direction according to the data arriving from each of the sensors 222. Compass sensor 228 is coupled with jib 204, supplying the controller with the azimuth of the long dimension of jib 204 relative to the true north. An independent safety threshold may be predefined in controller 110 for winds blowing at each dimension of jib 222, e.g., the side-lengthwise dimension; the “front”/“backward” dimension, “front” being the dimension facing the distal tip of jib 204 and backward being the respective opposite dimension; the bottom dimension, i.e., upward-blowing wind gusts; etc. The danger level of the blowing winds may also be considered by continuously evaluating the azimuth deviation of the working arm (i.e., jib) of a loose crane respective of wind direction, and detecting when the azimuth deviation and/or wind intensity are beyond a predetermined threshold which can lead to falling over of the crane. When controller 110 receives data from a wind sensor 222 indicative of a particular wind force and direction which exceeds the predefined force threshold for wind coming from that particular direction, it is configured to activate at least one alarm indicator to produce a sensory stimulation. As will be further explained, in some cases controller 110 may be configured to activated an automatic response which adjusts the position or angle of a crane component, e.g., jib 204, so as to remove the dangerous situation.

(2) Vibration/motion sensor 224 is coupled with a first coupling pin 208 of crane mast 202, and is configured to detect vibrations/movements of coupling pin 208, and transmit the data which it collects to controller 110. Tension sensor 225 is coupled with a second coupling pin 208 and is configured to measure the stress/tension being applied on coupling pin 208 by the crane elements whose coupling it is maintaining, and transmit the data which it collects to controller 110. Sensors 224 and 225 may both be coupled simultaneously with a single coupling pin. A safety threshold is predefined in controller 110 for vibration/motion levels and tension levels which are above a normal operating range and may be indicative of imminent danger and/or defective operating of crane 200. This threshold may vary with respect to each coupling pin 208, depending on the crane elements which it is coupling and the tension loads which it is designed to carry. For example, a first coupling pin 208 which is located at a bottom region of crane mast 202 is expected to work under a higher strain, and take a higher tension, than a second coupling pin 208 located at a top region of crane mast 202. When controller 110 receives data from sensors 224 and/or 225 indicative of a motion/vibration or tension in a coupling pin which exceeds the predefined threshold, it is configured to activate at least one alarm indicator to produce a sensory stimulation.

(3) Camera/radar sensor 226 is coupled with a hoist-and-hook 206, and is configured to continuously detect objects or constructions which are in proximity to the hoist-and-hook 206, measure the distance between hoist-and-hook 206 and the detected object, and transmit the data which it collects to controller 110. Controller 110 is configured to continuously calculate the changing of distance between hoist-and-hook 206 and the detected object, and/or to calculate the velocity/acceleration with which hoist-and-hook 206 is nearing the detected object, and a safety threshold is predefined in controller 110 for proximity, velocity and/or acceleration levels which are may be indicative of imminent danger. When controller 110 receives data from camera/radar sensor 226 from which it calculates a proximity/velocity/acceleration which exceeds the predefined threshold, it is configured to activate at least one alarm indicator to produce a sensory stimulation.

Reference is now also made to FIG. 1C, which illustrates coupled mutual detectors 230, mounted on crane 200 and on neighboring tree 160. A first mutual detector 230 is positioned near the end of hoist-and-hook 206, and a second mutual detector 230 is positioned on tree 160 at a location which lies within a potential trajectory of hoist-and-hook 206. Mutual detectors 230 are configured to constantly emit and receive wireless coupling signals 232 at a specific matching frequency and intensity, usually in an omni-directional pattern, such that when the first and second mutual detectors 230 come within a predefined distance of each other, each of detectors 230 will receive the coupling signal 232 transmitted by its corresponding detector 230, and will thereby identify the close presence of the corresponding detector 230. Alternatively, one of detectors 230, e.g., the detector mounted on tree 160, may be configured to only emit coupling signal 232, while the other corresponding detector 230, i.e., the detector which is installed on hoist-and-hook 206, may be configured to only receive signal 232. The emitting/receiving roles of the detectors 230 may also be interchanged according to need. Upon identifying the presence of the corresponding detector 230, detector 230 is configured to provide a signal to controller 110. The signal provided to controller 110 may be of an intensity which corresponds to the intensity of the coupling signal 232 which is received by detector 230, this intensity being correlated with the closeness of the two detectors 230. When controller 110 receives a signal from mutual detectors 230 of an intensity which exceeds a predefined threshold, it is configured to activate at least one alarm indicator to produce a sensory stimulation. This type of detection of a surrounding hazard may be utilized instead of or in addition to camera/radar sensor 226. Hazard detection which is based on mutual detectors 230 may be highly effective at recognizing predetermined hazards, but is not effective at recognizing incidental hazards which may chance into the vicinity of crane 200, for which camera/radar sensor 226 is more effective. Recognizing predetermined hazards is particularly effective in the context of crane operations, as when a crane is erected at a particular location, especially a tower crane, it is usually erected for a period ranging between several weeks to several months. Therefore, the surrounding constructions or objects which are potentially hazardous for the operation of crane 200 may be easily recognized and mapped out at the time of erection of crane 200. Dedicated independent mutual detectors 230 may be provided for each component of crane 200, and matching mutual detectors 230 may be installed on each component's corresponding potential hazards.

Upon recognition of a safety hazard/defect by controller 110, controller 110 is configured to activate one or more alarm stimulations, intended to draw the attention of operator 150 to the hazard/defect which has been recognized. The alarm stimulation may be produced, for example, by at least one of the alarm indicators 120, and may be directed to stimulate any of the five senses: touch, sight, hearing, smell and taste, and may additionally be directed to cause a psychological reaction. Some non-limiting examples of alarm indicators include: a display of a scenery of interest which is varied; a visual alert display, e.g., a written message or warning symbol appearing on screen 112; automatic focusing on an object of particular interest/requiring particular attention; a flickering light/display; a light-control for flickering the ambient lighting surrounding operator 150; a gas-sprayer for spraying strong smelling gas; an alarm for sounding a message/sound/alert, such as beeping, siren, a spoken command, screaming; a tactile vibrator for vibrating a handle/stick/chair in physical contact interface with operator 150; and an electric current in physical contact interface with the operator 150. The sprayer is implemented as an air brush in a certain embodiment, whereas in another embodiment it is implemented as heat element immersed in a liquid, whereas yet in another embodiment the sprayer is implemented as a solenoid actuated sprayer. Suitable liquids that can be vaporized or sprayed include skunk water available from Odortec at 21 AVIEZER, 9986000 Israel, or mercaptan based substances. In certain embodiments, putrid smelling gases like ammonia are released instead of spraying a liquid. In a variant embodiment, pleasant aromas are released instead of putrid smelling ones. Sample of liquid or gaseous aromas released are vanilla, musk, oud, or other perfuming agents know to those skilled in the art.

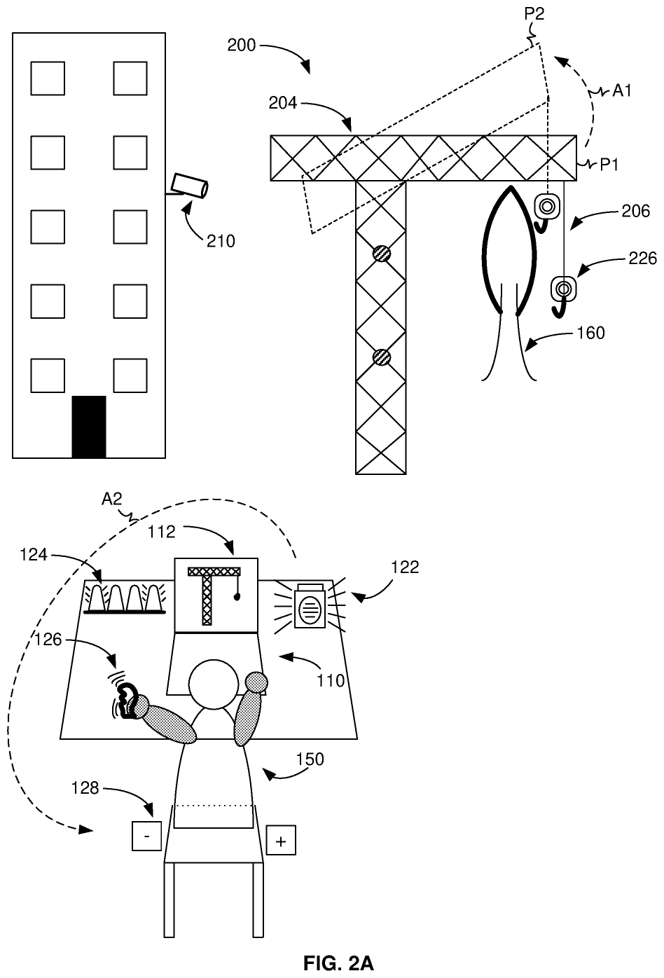

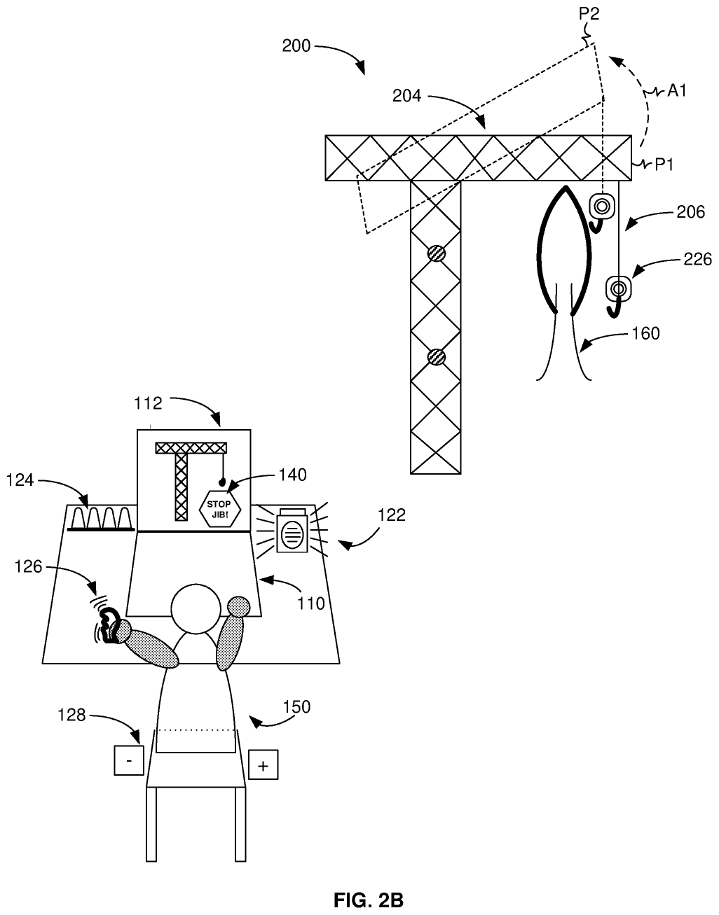

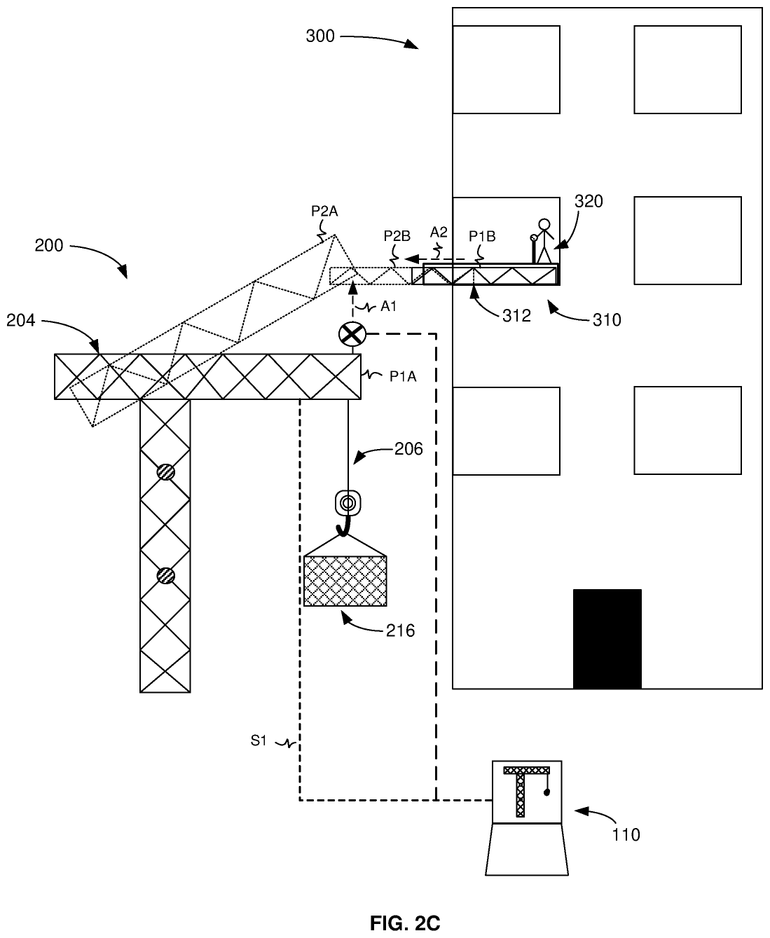

Reference is now made to FIG. 2A, which is an illustration of crane cockpit apparatus 100, where alarm indicators 120 are activated in response to a predicted hazard. Jib 204 of crane 200 suspends hoist-and-hook 206 from the end of jib 204 which is distal to crane mast 202. Camera/radar sensor 226 is coupled with hoist-and-hook 206, and visual recording device 210 is mounted upon a building in proximity to crane 200. Arrow A1 represents the trajectory of jib 204 from its initial position P1 to a second position P2. Arrow A2 represents a sequential activating of several alarm indicators 120, such that the advancement of jib 204 along arrow A1, and the activation of the indicators along arrow A2, are substantially correlated. In the initial position P1 of jib 204 hoist-and-hook 206 are at a safe working distance from any nearby object. As jib 204 is pivoted sideways along arrow A1, changing its azimuth relative to the true north, hoist-and-hook 226 is set in a motion in which it is brought in closer and closer proximity to tree 160. When this motion, i.e., velocity and/or acceleration, or proximity, cross a predefined threshold, controller 110 activates audio alarm 122, which in this embodiment is the first alarm indicator. Audio alarm 122 may be configured to produce any single sound or combination of sounds, the purpose of the sounds being to cause a sense of alert and urgency in operator 150. These sounds may include for example; beeping, ringing, siren-like sound, discordant music, hysterical screaming sound, or any other relevant sound. Operator 150 may be able, when setting up controller 110, to define a sound which he knows to be particularly effective on him. Alternatively, controller 110 may be configured to record the response time of operator 150 to various sounds, during operation sessions, and to analyze the collected information/data so as to define a most-effective audio stimulation for operator 150. This data collection and analysis may be performed for each operator independently, or may be performed for all operators collectively. If operator 150 does not respond to the stimulation produced by audio alarm 122, the response being either to stop the motion of jib 204 or to alter the course thereof, controller 110 will identify that the risk of collision with tree 160 is increasing and will proceed to activate the next alarm indicator, i.e., flickering light/display 124, either instead of or in addition to the first alarm indicator. Flickering light/display 124 may include lights flashing in a variety of different patterns, colors, intensities etc. Controller 110 may be connected to the surrounding lighting system of operator 150, and may be activated to turn off the surrounding lights, activate an emergency light, or induce a flickering pattern in the surrounding lighting. Alternatively, flickering light/display 124 may be projected upon screen 112, and may include a pop-up alert message or symbol, and/or different variations of the image of crane 200 which is presented on screen 112. The variations of the image of crane 200 may be general variations intended to draw the attention and instill a sense of urgency in operator 150, such as flashing of the screen image or changing the coloring to danger correlated shading; or the variations may be directed to focusing the operator on the particular detected threat, such as, in this example, focusing on and enlarging the image of hoist-and-hook 226 and tree 160, enhancing the strength of the coloring and/or contrast of these two features, etc. If operator 150 still does not respond to the stimulation produced by flickering light/display 124, either by stopping the motion of jib 204 or altering the course thereof, controller 110 will identify that the risk of collision with tree 160 is increasing and will proceed to activate the next alarm indicator, in this case tactile vibrator 126. Tactile vibrator 126 may include any device or artifact which is in physical contact with operator 150, preferably in substantially continuous contact therewith. This may include components of controller 110 which operator 150 utilizes to control the operation of crane 200, such as a computer mouse, a joystick, a dashboard, a smart screen (e.g., iPad) or any other buttons, levers and the like. Alternatively, vibrator 126 may include a desk, chair, cell phone, or any other proximate object. If also this sensory stimulation is not followed by a relevant reaction by operator 150, controller 110 activates an additional sensory stimulation, electric shocker 128. In order for shocker 128 to be effective, it should be in constant electrical communication with operator 150 throughout the crane operating session. Shocker 128 may be coupled with a desk, chair, or may include a dedicated button-like feature which may be coupled with operator 150 at the start of a crane operating session. The activation of shocker 128 will usually not be continuous, but will involve intermittent pulses. As will be further explained with regard to all sensory stimulations, the intensity and/or frequency of the electric pulse generated by shocker 128 may continuously rise, within a predefined safety range, if controller 110 still detects no response by operator 150 (i.e., no change of trajectory of jib 204).

The sequence of activation of the different alarm indicators 120 as represented by arrow A2 and described above is a non-limiting example. Any other sequence may be predefined in controller 110, under the general purpose of ensuring that operator 150 does not ignore the alarm stimulations and responds to the detected danger such that the danger/defect is resolved. The dynamic variation of the alarm stimulation can be according to several different lines of thought or principles, separately or in combination, which would entail different types of dynamic variation. For example, the principle of drawing the attention of operator 150 by surprising operator 150 may be applied, which could entail varying the stimulation by switching between two diverse types of stimulation, e.g., a beeping sound followed by squirting water, or alternating between activating a stimulation to stopping all stimulations so as to surprise operator 150 by the renewed stimulation. Any other line of thought which is conducive to drawing the attention of the operator and producing a suitable reaction to the danger/defect may be applied. Another example of a principle for dynamically varying the sensory stimulations is progressively augmenting the sensory stimulation, i.e., the strength/extremity of the stimulating effect, imposed upon operator 150 in correlation to increase of perseverance of the detected danger/defect, and progressively reducing the sensory stimulation in correlation to decrease in the detected danger. Some possibilities of dynamically varying the sensory stimulation will now be expanded upon and will be exemplified according to this principle, but these possibilities may be applied according to any other dynamic variation principle or line of thought.

When the dynamic variation of the sensory stimulation is based upon augmenting and reducing the intensity or strength of the sensory stimulations, the relative extremity of the various sensory stimulations is a first consideration in planning their sequence of activation. The relative extremity of sensory stimulation may be evaluated, for example, according to the irritation level of the particular chosen stimulation (e.g., mellow beeping sound vs. screechy wailing sound), the stimulation's intensity (sound volume/light intensity/strength of vibration, etc.), and that of the five senses which it stimulates, wherein it is generally accepted that the average sensitivity scale of the five senses (from highest to lowest) is hearing, touch, sight, and smell, at least from the point of view of reaction-time (RT) (i.e., hearing has the fastest RT). Each specific sensory stimulation may be assigned a “stimulatory score” in controller 110, for example according to the above-outlined parameters. Various alarm sequence programs may be defined in controller 110 based on the stimulatory score of the different sensory stimulations, such as: a linear progression between sensory stimulations in correlation with linear increase in danger level (e.g., stimulatory scores 1, 2, 3, 4); an exponential progression between sensory stimulations in correlation with linear increase in danger level (e.g., stimulatory scores 1, 10, 100); a progression of stimulations in a step intervals function in correlation with linear increase in danger level, e.g., for every 5 seconds of danger perseverance increasing the sensory stimulation by several degrees (e.g., stimulatory scores 5, 10, 15, 20); a progression of stimulations directed towards the same sense, e.g., various sounds with progressing stimulatory scores; a progression of stimulations directed towards alternating senses; an accumulation of stimulations; and any combination of the above. As was briefly explained with relation to audio alarm 122, it is noted that the progression of stimulations may be defined by operator 150, when setting up controller 110 at the start of a crane-operating session, according to a sequence which operator 150 knows to be progressively stimulating/alarming for him. Alternatively, controller 110 may be configured to record the response time and the response quality of operator 150 to various stimulations, i.e., how fast and how accurately operator 150 reacts to each sensory stimulation, during operation sessions, and to analyze the collected information/data so as to define a stimulation scale for operator 150. The quality of the response of operator 150 is important as well as the speed of the reaction, as certain sensory stimulations may be found to be too alarming, so as to cause operator 150 excess stress, leading to a misguided or non-accurate reaction. The quality of the reaction may be assessed, for example, by comparing the operations of operator 150 in response to the sensory stimulation with a predefined optimal response to a detected danger of the sort. This data collection and analysis may be performed for each operator independently, or may be performed for all operators collectively, i.e., whereas controller 110 analyzes and defines a general stimulation scale for all potential operators. Controller 110 may also be configured to randomly change the stimulations, or the sequence of stimulations, so as to prevent operator 150 from getting used to a repeated sequence. Alternatively, controller 110 may be configured to alternate between a fixed stimulation sequence and a randomly changing stimulation sequence; to record the time and precision of the response of operator 150 to these alternative sequences; to analyze the recorded data; and to define a preferred method of applying stimulations-randomly changing stimulations and stimulation sequences, or fixed stimulations and stimulation sequences. The terms “randomly changing stimulations” and “fixed stimulations” include a range of intermediate options, such as: alarm stimulations randomly changing with every event in which controller 110 begins activating alarm indicators; randomly changing every crane-operating session; randomly changing every week/every month; etc.

Reference is now also made to FIG. 2B, which is an illustration of an activation of a required-action indicator 140 by controller 110. Required-action indicator 140 is an eye-catching visual message which appears upon screen 112, and informs operator 150 what action is required in order to prevent the potential hazard and/or amend the detected defect. This is a different emphasis from alarm indicators 120, which are mainly directed at drawing the attention of operator 150 and creating a sensation of alarm, and urgency to respond to the upcoming hazard or defect. Of course, an alarm indicator 120 may also produce positive indications (i.e., serve as a required-action indicator), and a particular alarm stimulation may include a combination of urgency-producing elements and positive indicating elements (examples are forthcoming). Controller 110 may activate required-action indicator 140 before, simultaneously with, or after activating alarm indicators 120. Required-action indicator 140 may include, for example, a written message appearing on screen 112 or on any other relevant surface; a spoken order/message from an audio speaker, e.g., audio alarm 122; a vibration in a required direction of a joystick or any other physical object which operator 150 uses to handle crane 200; an eye-catching lighting-up of a button which operator 150 is required to press on, the button including computer keyboard keys, digital buttons or tabs which appear on screen 112, levers, and the like; and any combination of the above. As can be seen, several of these examples can serve substantially simultaneously both as alarm stimulations and as positive indications. For example, a vibrating joystick may also serve to alarm operator 150 with physical vibrations, possibly at increasingly intensity, and may at the same time indicate the required action to operator 150 by vibrating in the required direction. Another example is an audio alarm indicator which produces an ongoing sound alert, the sound alert alternating between urgency-inducing sounds and spoken instructions.

Reference is now made to FIG. 2C, which illustrates an example of an automatic intervention response of controller 110 to a suddenly appearing hazard. Crane 200 is erected in proximity to under-construction-building 300. Deployable platform 310 is positioned in an alcove of building 300 with an opening in the direction of crane 200, such that arm 312 of deployable platform 310 can be deployed outward from building 300, along trajectory A2, in the direction of crane 200, for example for receiving a load which is delivered by cane 200. Construction worker 320 operates deployable platform 310, e.g., by using a lever, to deploy and retract arm 312. Jib 204 of crane 200 carries load 216 using hoist-and-hook 206, and is operational, amongst other movements, to raise and lower the distal end of jib 204 along trajectory A1, i.e., the end of jib 204 from which hoist-and-hook 206 is suspended. As previously described, controller 110 controls the movement of jib 204 and is usually operated by an operator. In the illustrated scenario, controller 110 is operated by an operator to produce an operator-signal S1 so as to raise the distal end of jib 204 along trajectory A1, in order to deliver load 216 to an elevated position within building 300. However, as jib 204 is rising towards its intended destination, construction worker 320 pulls lever 322 for some reason, thereby deploying arm 312 of deployable platform 310 along trajectory A2. Arm 312 extends outward such that it is positioned directly within the intended movement pathway of jib 204. Controller 110 recognizes the imminent collision by analyzing the ongoing data which it receives from sensors disposed on crane 200 (not shown), and identifies that if the ongoing operation of raising jib 204 continues at its current velocity, jib 204 will collide with deployable platform 310 within a very short time period, in which time period an operator would not succeed in responding to an alarm sensory stimulation to prevent the collision. Controller 110 therefore produces an automatic-signal S2 which brings jib 204 to an immediate stop, overriding operator-signal S1 under which jib 204 was previously operating. Controller 110 may be operational to provide an automatic-signal intervention response so as to prevent any other type of dangerous situation, and the automatic-signal intervention response may entail activating any component of crane 200 or any other component which is controlled by controller 110. Some further examples include: (a) controller 110 operating a slewing mechanism which controls the azimuth of jib 204, and the vertical angle of jib 204 relative to the horizon, so as to adjust the direction and/or tilt of jib 204 relative of a blowing wind, when a wind blows against jib 204 at a direction and intensity which are above a predefined threshold, for preventing falling over of the crane; (b) controller 110 operating a trolley which is operational to travel back-and-forth along jib 204, from which trolley is suspended load-carrying hoist-and-hook 206, such that if a truck, animal, or the like suddenly enter into the immediate course of the trolley, controller 110 produces a signal to halt or retract the trolley; and the like.

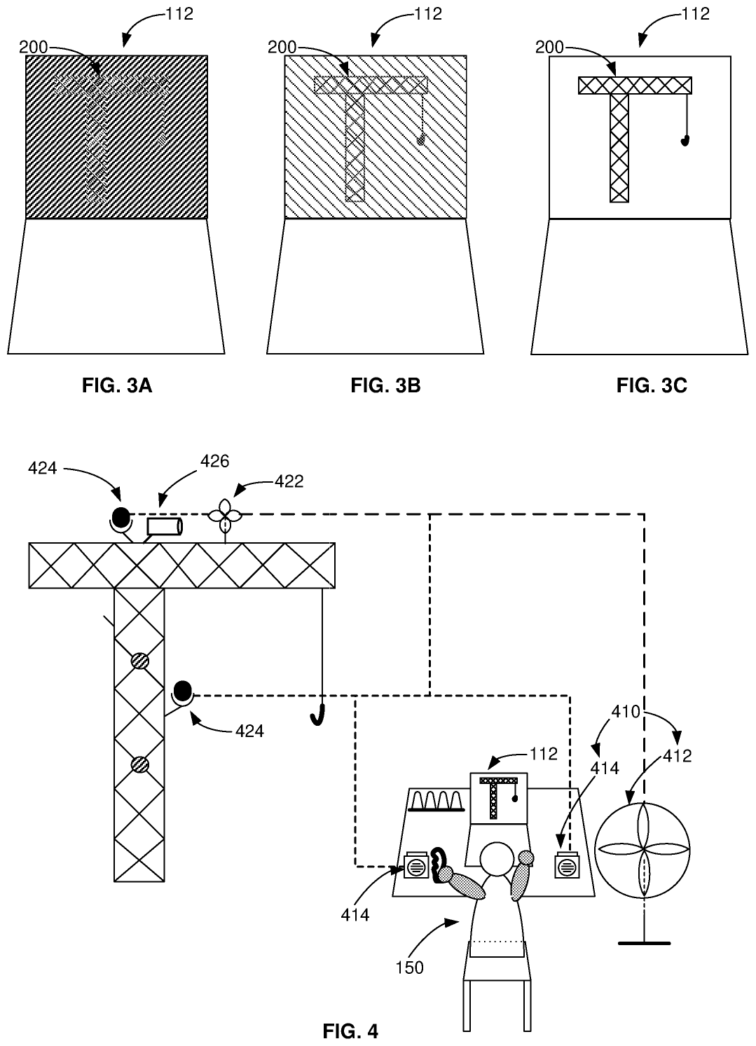

Reference is now made to FIGS. 3A to 3C, which are sequential live images of crane 200 shown upon screen 112, with changing display settings in response to data received by controller 110, which is indicative of a potential defect or hazard for crane 200. In FIG. 3A a visual display of real time imaging of a scene of interest is shown on screen 112, the scene of interest including crane 200, where the contrast between crane 200 and its background environment is at a baseline level. This baseline contrast level may be representative of a normal view of crane 200 as would be seen by an operator sitting within a non-remote crane cockpit, a contrast level which is suitable for easy tracking of the operation and motion of crane 200 within its background environment. When controller 110 identifies a potential defect or hazard, the contrast level of the image on screen 112 is progressively augmented, serving as a visual sensory alarm stimulation of the operator, as is shown in FIG. 3B. The contrast between crane 200 and its background environment is increased in comparison to the baseline level shown in FIG. 3A. Increasing the contrast between crane 200 and the environment is intended to draw the attention of the operator to the potentially dangerous situation of crane 200 in several ways: by emphasizing the motion of crane 200 in relation to its general background; by causing a visual discomfort to the operator due to the unnaturally contrasted image; and/or by capturing the operator's attention due to the sudden change of contrast. The contrast level of the entire image shown on screen 112 may be adjusted. Alternatively, only the contrast of crane 200, and possibly its proximal surroundings, may be increased, and optionally also the contrast of an object which presents a potential hazard for crane 200. The contrast level may be adjusted gradually, i.e., continuously rising as the hazard increases and/or perseveres and continuously decreasing as the hazard potential decreases, or may be adjusted in leaps according to predefined step levels of hazard increase/hazard time extent. Contrast adjustment by leaps may be more effective in capturing the attention of the operator. If controller 110 detects that the operator has not responded to the increase in contrast by taking action to avert the potential danger and/or amend the defect, controller 110 may further increase the contrast of the image on screen 112, as shown in FIG. 3C.

Controller 110 may apply other changes to the display settings of the image on screen 112, as a visual alarm stimulation of the operator and/or to enhance the focus on crane 200, the display settings including for example: brightness, sharpness, shading, coloring strength, coloring heat (where hot coloring is substantially yellow, orange and red, and cold coloring is substantially green, clue, indigo and violet), and the like. Each of these display characteristics may be augmented as a hazard or defect increases/perseveres, and may be reduced as the risk of hazard is alleviated or the defect remedied.

Reference is now made to FIG. 4 which illustrates real-time-conditions indicators 410 located in the vicinity of operator 150, intended for enhancing the sensory experience of operator 150 during the operation of crane 200 to imitate a sensory experience of an operator residing within a cockpit located at the top of a crane. Real-time-conditions indicators 410 are located in the vicinity of operator 150, near enough to provide sensory data to operator 150. Real-time-conditions indicators 410 include wind-emitter/fan 412 and surround-speaker 414. Preferably, fan 412 includes a plurality of fans which are positioned at least two different sides of operator 150, and surround-speaker 414 includes a plurality of speakers which are positioned at least two different sides of operator 150. Controller 110 receives data that is sensed or perceived by wind sensors 422 and sound sensors 424 (i.e., microphones) which are installed in the vicinity of crane 200, and regulates the activation, intensity, directionality and/or other characteristics of real-time-conditions indicators 410 such that they imitate the data received from the sensors. An image sensor 426 (similar to visual recording device 210) is also positioned on crane 200 and provides real-time imaging to screen 112. The more positions of fans and/or speakers there are, the better the ability of controller 110 to produce a sensory surround effect which accurately imitates the real-time conditions surrounding the crane.

For example, when controller 110 receives audio data of real-time environmental noises (e.g., an audio signal emitted by a truck driving in reverse) from a microphone disposed on the right-hand side of crane 200, where right-hand side is defined relative to a theoretical operator sitting within a crane cockpit at the top of the crane, controller 110 may be operational to activate surround speaker 414 to produce a corresponding audio signal. When there are a plurality of speakers, controller 110 may activate the speaker or speakers which are positioned in a corresponding right-hand side of operator 150. This creates a sensory experience for operator 150 which is similar to the sensory experience which operator 150 would have if he were actually located at the top of crane 200. A similar process is carried out with fan 412, where the wind sensors of crane 200 provide wind data to controller 110 (e.g., intensity and directionality of a gust of wind), and controller 110 activates the corresponding fan or fans to produce a sensory experience for operator 150 which corresponds to real-time conditions. Alternatively or additionally to the activation of fan 412, controller 110 may activate surround-speaker 414 to produce wind-blowing sounds when a substantial wind is blowing on crane 200. Creating a surrounding sensory experience for operator 150 which corresponds to the real-time conditions may increase operator 150's understanding of the situation of crane 200, and substantially enhance operator 150's awareness of potential threats or dangers to crane 200, even without controller 110 activating alarm indicators. Real-time-conditions indicators 410 may also include additional elements such as a vibrating chair, for imitating vibrations of a non-remote cockpit due to strong wind or movements of the crane, and the like. Optionally, the sensors installed on crane 200 are installed in the location on crane 200 which would be occupied by a non-remote crane cockpit, and are arranged such that they perceive the surrounding conditions as would be perceived by an operator within the non-remote cockpit. This option is particularly useful for a crane operator who is experienced in operating a crane from a non-remote cockpit, where the data collected by the sensors allows the real-time-conditions indicators 410 to produce a sensory experience corresponding to what the operator is used to from his experience in a non-remote cockpit. Alternatively, the sensors may be distributed and arranged in any position in the vicinity of crane 200 which allows sensing wind, sounds, or any other relevant surrounding data which can enhance the ability of operator 150 to sense the conditions surrounding crane 200, even if the data sensed by the sensors would not be perceived by operator 150 if he were situated within the non-remote cockpit. This allows operator 150 to acquire enhanced sensory indications which are not limited to the detecting abilities of his own senses, as is the case in a non-remote cockpit, and this may increase his understanding of the surrounding of crane 200 and help him better forecast potential hazards or dangers. There is a risk that for an operator experienced with non-remote cockpit operation, these additional sensory indications may be potentially misleading, as he is generally accustomed to perceiving only what he can pick up with his own senses. To overcome this issue, a program may be predefined in controller 110 such that controller 110 may at first filter out, i.e., not express via real-time-conditions indicators 410, data which is beyond the scope of what an operator in a non-remote cockpit would pick up, and gradually add and express data which is received from more distant sensors, such that operator 150 can become accustomed to this broadening of sensory input. In addition, a plurality of image sensors 426 may be mounted at different locations in the vicinity of crane 200 such that each image sensor provides real time imaging of a different region and/or angle of crane 200. When sensory data is perceived by at least one of the other sensors, e.g., wind sensors 422 and sound sensors 424, and expressed by controller 110 via real-time-conditions indicators, controller 110 may be configured to display on screen 112 a live time imaging of the corresponding crane location. For example, if a sound sensor 424 which is located at a rear side of the crane jib (the side opposite to the hoist-and-hook) provides unusual audio data which is expressed via a surround-speaker 414, a corresponding live imaging of the rear side of crane 200 may be displayed on screen 112. This possibility may be useful for any operator, and may be particularly useful for an operator that is experienced in non-remote crane cockpit operation, to become accustomed to wider sensory input.

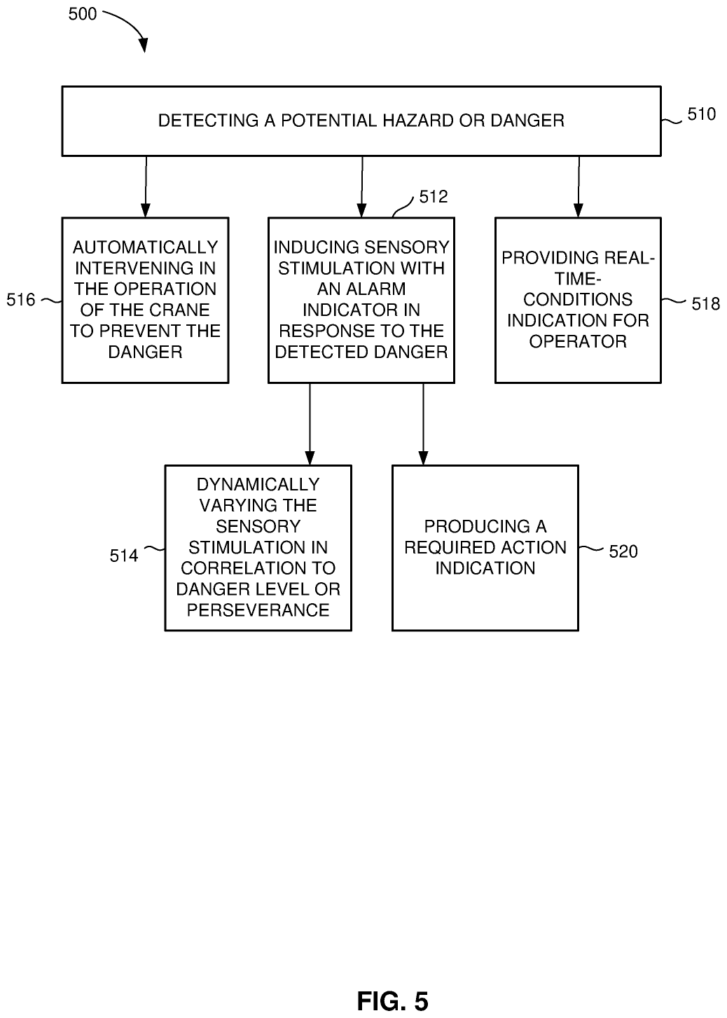

Reference is now made to FIG. 5, which is a block diagram of a method, denoted 500, for remotely controlling crane cockpit for at least one crane by an operator, operative in accordance with an embodiment of the present invention. In procedure 510, a potential danger or hazard is detected by a controller, which receives data from danger sensors in the vicinity of a crane. The potential danger may be detected by continuously evaluating the azimuth deviation of the working arm of a loose crane respective of wind direction, and detecting when wind intensity is above a threshold which can lead to falling over of the crane. Referring to FIGS. 1A-1C, danger sensors 220 provide data to controller 110, which continuously analyses the provided data according to a predefined program in order to identify a potential danger/hazard.

In procedure 512, a sensory stimulation is produced by an alarm indicator in response to the detected danger, intended to alert the crane operator to respond to the imminent danger. Referring to FIG. 2A, at least one of alarm indicators 120 is activated by controller 110 in response to the detected danger, so as to alert operator 150 to alter the operation/situation of crane 200 to prevent the potential danger.

In procedure 514, the sensory stimulation is dynamically varied by the controller, in correlation to changing of the danger level or perseverance of the dangerous situation. One possibility of dynamically varying is that the sensory stimulation is progressively augmented in correlation to increase of danger level or perseverance, and is progressively reduced in correlation to decrease of danger level or perseverance. The sensory stimulation may be dynamically varied in response to a detected danger according to a fixed program. Alternatively, the sensory stimulation may be dynamically varied in response to each detected danger according to a randomly changing program. The rate of variation of the sensory stimulation in correlation to danger increase and/or perseverance may include at least one of the following: a linear rate of variation, an exponential rate of variation, variation by a step interval function. Referring to FIG. 2A, controller 110 dynamically varies the sensory stimulations produced by alarm indicators 120 in correlation to the detected danger persevering or escalating. The activation of alarm indicators 120 in correlation to danger increase or perseverance may be according to a fixed program, i.e., activating the same sequence of alarm indicators 120 to produce the same types of signals, in response to every danger detection, or may be according to a randomly changing program of activation of alarm indicators 120 for each danger detection.

In procedure 516, which is a sub-procedure of procedure 510, an automatic intervention is activated in response to the detected danger, when the danger is assessed to be too imminent, which halts or changes the trajectory and/or position of any component of the crane to actively prevent a dangerous situation. The activation of the automatic intervention may include correcting azimuth deviation of the working arm of a loose crane respective of wind direction when the azimuth deviation and/or wind intensity are above a predefined threshold, for preventing falling over of the crane. Referring to FIG. 2C, controller 110 activates an automatic intervention which halts or otherwise alters the trajectory of jib 204 of crane 200, in response to a detected danger.

In procedure 518, which is a sub-procedure of procedure 510, real-time-conditions indications are provided for the operator, for increasing the operator's sensory experience and understanding of the conditions surrounding the crane. Providing real-time-conditions indications may include, for example, sounding crane real time environmental noises as heard and perceived by a microphone in the vicinity of the monitored crane, simulating the windblow at a cockpit location of the monitored crane by blowing air toward the operator and/or sounding windblow sounds, and/or vibrating a seat on which the operator is sitting for imitating vibrations at a cockpit-location of the monitored crane due to strong wind or movements of the crane. Referring to FIG. 4, real-time-conditions indicators 410 increase the sensory experience of operator 150 during the operation of crane 200, where surround-speaker 414 imitates sounds picked up from the vicinity of crane 200 and wind-emitter/fan 412 imitates wind blowing in the vicinity of crane 200.

In procedure 520, which is a sub-procedure of procedure 512, a required-action indication is produced in response to the detected danger/defect, intended to direct the crane operator to carry out a suitable response. Referring to FIG. 2B, controller 110 activates required-action indicator 140, optionally upon screen 112, in response to the detected danger, which informs operator 150 action is required in order to prevent the potential danger and/or amend the detected defect.

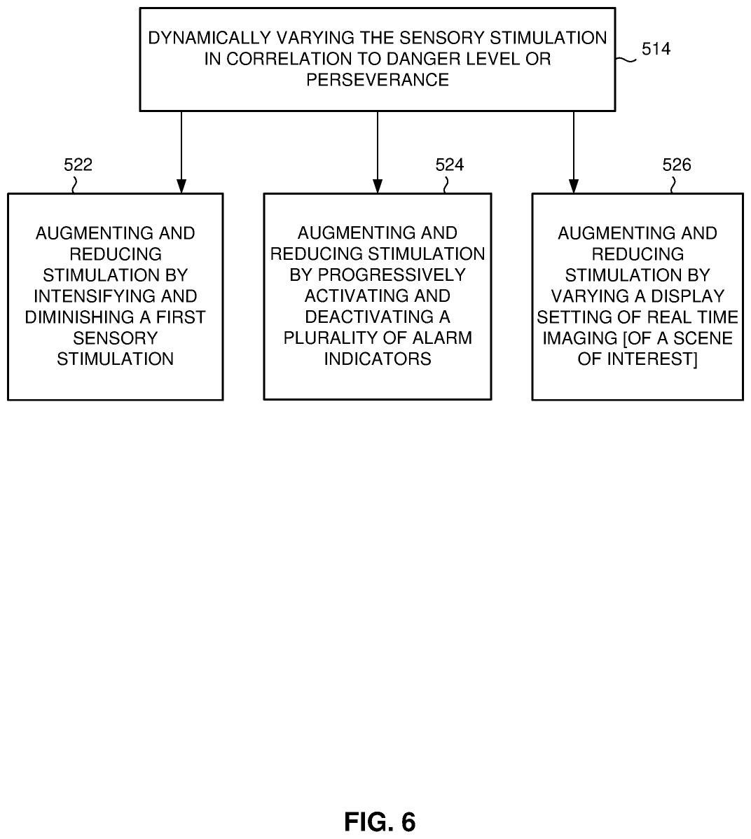

Reference is now made to FIG. 6, which is a block diagram of sub-routines or sub-procedures of step 514 of the embodiment of FIG. 5. In procedure 522, the sensory stimulation is progressively augmented by intensifying a first sensory stimulation produced by a first alarm indicator, and is progressively reduced by diminishing the first sensory stimulation produced by the first alarm indicator. Referring to FIG. 2A, a first alarm stimulation produced by a first one of alarm indicators 120 is intensified by controller 110 in correlation to danger increase or perseverance, and is diminished by controller 110 in correlation to danger decrease.

In procedure 524, the sensory stimulation is progressively augmented by activating a plurality of alarm indicators which respectively produce a plurality of sensory stimulations, and is progressively reduced by deactivating the plurality of alarm indicators. Referring to FIG. 2A, a plurality of alarm stimulations produced by a plurality of alarm indicators 120 is successively activated by controller 110 in correlation to danger increase or perseverance, and are successively deactivated by controller 110 in correlation to danger decrease.

In procedure 526, the sensory stimulation is dynamically varied by progressively augmenting a display settings of real time imaging of a scene of interest in correlation to danger increase/perseverance, and progressively diminishing the visual characteristic of real time imaging of a scene of interest in correlation to danger decrease. The visual characteristic may include scene shading, scene coloring, i.e., strong colors and soft colors, and scene brightness. Referring to FIGS. 3A-3C, display settings of live images of crane 200 shown upon screen 112 are changed in response to data received by controller 110, which is indicative of a potential defect or hazard for crane 200.

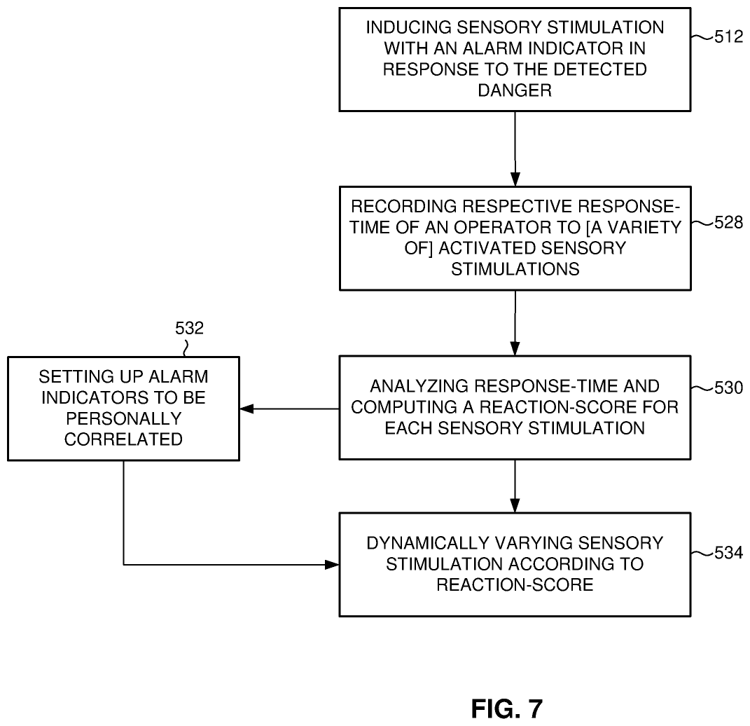

Reference is now made to FIG. 7, which is a block diagram of sub-routines or sub-procedures of step 512 of the embodiment of FIG. 5. In procedure 528, a respective response-time and response quality of an operator is recorded for each of a variety of sensory stimulations produced by the alarm indictors in response to a detected danger. Referring to FIG. 2A, controller 110 records the time and quality of the response of operator 150 to each sensory stimulation produced by one of alarm indicators 120.

In procedure 530, the response-time and/or quality of response to each of the various sensory stimulations is analyzed, and a relative reaction-score is computed and defined for each sensory stimulation. Referring to FIG. 2A, controller 110 analyzes the response-time and response quality of operator 150 to each of the various sensory stimulations, and computes and defines a relative reaction-score for each sensory stimulation.

In procedure 532, the alarm indicators are set up so as to be personally correlated to a particular operator, according to the analyzed response-time and response-quality of the particular operator to the different sensory stimulations. Referring to FIG. 2A, the various alarm indicators 120 are positioned and otherwise set up such that they can produce sensory stimulations, in response to a detected danger, which correspond to a personalized reaction-score of the sensory stimulations which was defined for a specific operator 150.

In procedure 534, the sensory stimulations are dynamically varied, in correlation to increasing or diminishing of the detected danger, according to the computed reaction-score. The dynamic variation may be to progressively augment and reduce the sensory stimulation according to the reaction-score in correlation to increase and decrease of the detected danger, respectively. The reaction-score may be computed and defined separately for each operator, or may be computed and defined generally, by analyzing the reaction-time and reaction-quality of operators in general to different sensory stimulations. Referring to FIG. 2A, controller 110 activates alarm indicators 120 to produce sensory stimulations according to the computed reaction-score.

While certain embodiments of the disclosed subject matter have been described, so as to enable one of skill in the art to practice the present invention, the preceding description is intended to be exemplary only. It should not be used to limit the scope of the disclosed subject matter, which should be determined by reference to the following claims.

1. Remote crane cockpit apparatus for remotely controlling at least one crane by an operator, comprising:
a disregard-thwarting system for thwarting disregard of alarm indication by the operator, the system comprising:
at least one alarm indicator configured to induce sensory stimulation, wherein said sensory stimulation is dynamically varied in correlation to danger level or perseverance, wherein said alarm indication includes a secondary sense stimulator.

2. The remote crane cockpit apparatus of claim 1, wherein said secondary sense stimulator includes at least one of:
a tactile stimulator;
an electric shocker;
a chair heater configured to heat a recoil temperature; and
a sprayer, operative to release an odorous scent.

3. (canceled)

4. The remote crane cockpit apparatus of claims 2, wherein said tactile stimulator includes a tactile vibrator.

5. (canceled)

6. (canceled)

7. The remote crane cockpit apparatus of claim 1, wherein said sensory stimulation is progressively augmented by intensifying a first sensory stimulation produced by a first alarm indicator, and is progressively reduced by diminishing said first sensory stimulation produced by said first alarm indicator.

8. The remote crane cockpit apparatus of claim 1, wherein said sensory stimulation is progressively augmented by activating a plurality of alarm indicators which respectively produce a plurality of sensory stimulations, and is progressively reduced by deactivating said plurality of alarm indicators.

9. The remote crane cockpit apparatus of claim 1, wherein said sensory stimulation is dynamically varied according to a fixed program.

10. The remote crane cockpit apparatus of claim 1, wherein said sensory stimulation is dynamically varied according to a randomly changing program.

11. Remote crane cockpit apparatus for remotely controlling at least one crane by an operator, comprising:
a disregard-thwarting system for thwarting disregard of alarm indication by the operator, the system comprising:
at least one alarm indicator configured to induce sensory stimulation, wherein said sensory stimulation is dynamically varied in correlation to danger level or perseverance,
a controller, wherein said controller is configured to:
record respective response-time of an operator to a variety of activated sensory stimulations;
analyze said response-time of said operator;
define a reaction-score of said operator to each of said variety of activated sensory stimulations; and
dynamically vary said sensory stimulation according to said reaction-score.

12. The remote crane cockpit apparatus of claim 1, wherein said sensory stimulation comprises a visual display of real time imaging of a scene of interest, wherein said sensory stimulation is progressively augmented or reduced by variation of scene shading between calm shading and strong shading.

13. The remote crane cockpit apparatus of claim 1, wherein said sensory stimulation comprises a visual display of real time imaging of a scene of interest, wherein said sensory stimulation is progressively augmented or reduced by variation of scene coloring between soft colors and strong colors.

14. The remote crane cockpit apparatus of claim 1, wherein said sensory stimulation comprises a visual display of real time imaging of a scene of interest, wherein said sensory stimulation is progressively augmented or reduced by variation of brightness.

15. The remote crane cockpit apparatus of claim 1, wherein said alarm indicator comprises a required-action indicator.

16. The remote crane cockpit apparatus of claim 1, wherein said system further comprises a real-time-conditions indicator for imitating real-time conditions of the monitored crane.

17. The remote crane cockpit apparatus of claim 16, wherein said real-time-conditions indicator comprises at least one of the following:
surround-speaker for sounding crane real time environmental noises as heard and perceived by a microphone in the vicinity of the monitored crane;
wind simulator for simulating the windblow at a cockpit-location of the monitored crane by blowing air and/or sounding windblow sound; and
a vibrating seat, for imitating vibrations at a cockpit-location.

18. The remote crane cockpit apparatus of claim 1, wherein the danger level is considered by evaluating azimuth deviation of the working arm of a loose crane respective of wind direction when wind intensity is above a threshold which can lead to falling over of the crane.

19. The remote crane cockpit apparatus of claim 1, further comprising: an automatic intervention controller configured to actively prevent a dangerous situation.

20. The remote crane cockpit apparatus of claim 19, wherein said automatic intervention controller is operative to control a slewing means for correcting azimuth deviation of the working arm of a loose crane respective of wind direction when said azimuth deviation and/or wind intensity are beyond a threshold, for preventing falling over of the crane.

21. The remote crane cockpit apparatus of claim 1, wherein said alarm indicator is personally setup for a particular operator, and is configured for an initial setup suited to the particular operator.

22. Method for remotely controlling crane cockpit for at least one crane by an operator, comprising:
detecting a potential danger by at least one danger-sensor in the vicinity of said at least one crane;
inducing sensory stimulation with at least one alarm indicator in response to the detected danger; and
dynamically varying the sensory stimulation in correlation to danger level or perseverance,
wherein said alarm indicator includes a secondary sense stimulator.

23. (canceled)

24. (canceled)

25. (canceled)

26. (canceled)

27. (canceled)

28. (canceled)

29. (canceled)

30. (canceled)

31. (canceled)

32. Method for remotely controlling crane cockpit for at least one crane by an operator, comprising:
thwarting disregard of alarm indication by the operator, by:
detecting a potential danger by at least one danger-sensor in the vicinity of said at least one crane;
inducing sensory stimulation with at least one alarm indicator in response to the detected danger;
dynamically varying the sensory stimulation in correlation to danger level or perseverance;
recording respective response-time and/or quality of response of an operator to a variety of activated sensory stimulations;
analyzing said response-time and/or quality of response of said operator;
computing and defining a reaction-score of said operator for each of said variety of activated sensory stimulations; and
dynamically varying said sensory stimulation according to said reaction-score

33. (canceled)

34. (canceled)

35. (canceled)

36. (canceled)

37. (canceled)

38. (canceled)

39. (canceled)

40. (canceled)

41. (canceled)

42. (canceled)
